(19) United States
(12) Patent Application Publication
(10) Pub. No.: US 2016/0042241 A1
(43) Pub. Date: Feb. 11, 2016

(54) INTERACTIVE INDICIA READER

(71) Applicant: Hand Held Products, Inc., Fort Mill, SC (US)

(72) Inventor: Erik Todeschini, Camillus, NY (US)

(21) Appl. No.: 14/452,697

(22) Filed: Aug. 6, 2014

(51) Int. Cl. G06K 9/22; G06K 19/06; G06K 9/00; G06K 9/32; G06F 3/01; G06F 3/0354

(52) U.S. Cl. CPC G06K 9/228; G06F 3/017; G06F 3/03545; G06K 9/00355; G06K 9/3233; G06K 19/06028

(57) ABSTRACT

An interactive indicia (e.g., barcode) reader is disclosed. This indicia reader incorporates a projector to display context sensitive information on a surface. This information may represent manufacturer or store related information about the item with the indicia. What is more, the indicia reader may also recognize a user's interaction with the projected image. In this way, the indicia reader may enhance the information that it provides, as well as expanding the data that it can collect.

### FIELD OF THE INVENTION

The present invention relates to indicia readers, and more specifically, to an indicia reader with an interactive interface.

### BACKGROUND

Generally speaking, indicia reading (i.e., barcode scanning) has proven to be an effective means for identifying items at the point of sale (i.e., checkout). Traditional handheld, barcode scanners are deterministic, however, and therefore do not to allow a user (e.g., a customer) to alter the barcode scanner's decoded results. What is more, the inflexibility of these barcode scanners limit their possible uses at checkout. One thing limiting some traditional barcode scanners is a versatile interface for customer interaction. As a result, these barcode scanners must be used with other equipment in order to provide a customer interface, thereby adding cost and size to the overall system.

Therefore, a need exists for a barcode reader with a versatile user interface that can display contextual information about a scanned barcode as well as accepting input from a user.

### SUMMARY

Accordingly, in one aspect, the present invention embraces an interactive indicia reader that includes modules supported, positioned, and contained by a housing. An imaging module is used to capture images of a field of view. These images may include indicia and/or user gestures. A projecting module is used for projecting context-sensitive information, and a memory module is used for storing the context-sensitive information. A processor module is communicatively coupled with the imaging module, the projecting module, and the memory module. This processor module is configured to decode the indicia and the user gestures captured by the imaging module. The processor is further configured to retrieve (from the memory module) the context-sensitive information corresponding to either the decoded indicia or the decoded user gestures. The processor is also configured to provide this context-sensitive information to the projecting module.

In another aspect, the present invention embraces an interactive barcode reading system including a barcode reader for capturing images within a barcode-reader field-of-view. These images include barcodes and/or user-input gestures. The system also includes a projector that is physically integrated with the barcode reader. The projector is configured to project messages within a projector field-of-view that coincides with, at least part of, the barcode-reader field-of-view. The interactive barcode reader system also includes a host computer communicatively coupled with the barcode reader and the projector. The host computer is configured to receive images from the barcode reader and to process these images. This processing includes decoding the barcodes, recognizing the user-input gestures, generating messages, and transmitting the messages to the projector.

In yet another aspect, the present invention embraces a method for obtaining user-input information using a barcode reader. The method includes the steps of: (i) acquiring a barcode image of a barcode on an item in a barcode reader field-of-view; (ii) decoding the barcode image's barcode information; (iii) gathering supplemental information corresponding to the barcode information; (iv) projecting the supplemental information into a projector field-of-view; (v) acquiring user-input images that convey a user's interaction with the projected supplemental information; and (vi) decoding the user-input images to obtain user-input information.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 graphically depicts an interactive indicia reader projecting information corresponding to a barcode.

FIG. 2 graphically depicts an interactive indicia reader projecting a virtual control in the form of a keypad.

FIG. 3 graphically depicts the interactive indicia reader projecting a signature prompt and visual feedback of the captured signature.

FIG. 4 graphically depicts a block diagram of an exemplary interactive indicia reader.

FIG. 5 illustrates an exemplary interactive barcode reading system.

### DETAILED DESCRIPTION

The present invention embraces an indicia reader (e.g., barcode reader) with an optical interface to allow for the display of, and interaction with, messages (i.e., context-sensitive information). The optical interface may use a projector, integrated with the barcode reader, to project the contextual messages onto a surface chosen by an operator. An imaging module (e.g., camera module), integrated with the indicia reader, is used to capture a user's interaction with the contextual messages. The resulting interface enhances the indicia reader's capabilities and contributes to the reader's versatility.

Traditionally speaking, barcode scanning is deterministic and not flexible enough to allow a user's input to alter the result of the identification or provide real-time feedback to the operator and/or customer. These barcode scanners (i.e., indicia readers) often have no means of accepting user input or displaying information about identified items. A user interface is needed. The interface disclosed here provides a means for: (i) identifying the scanned item, (ii) describing information corresponding to the scanned item, and (iii) allowing for user input, including user input information regarding how that item should be processed.

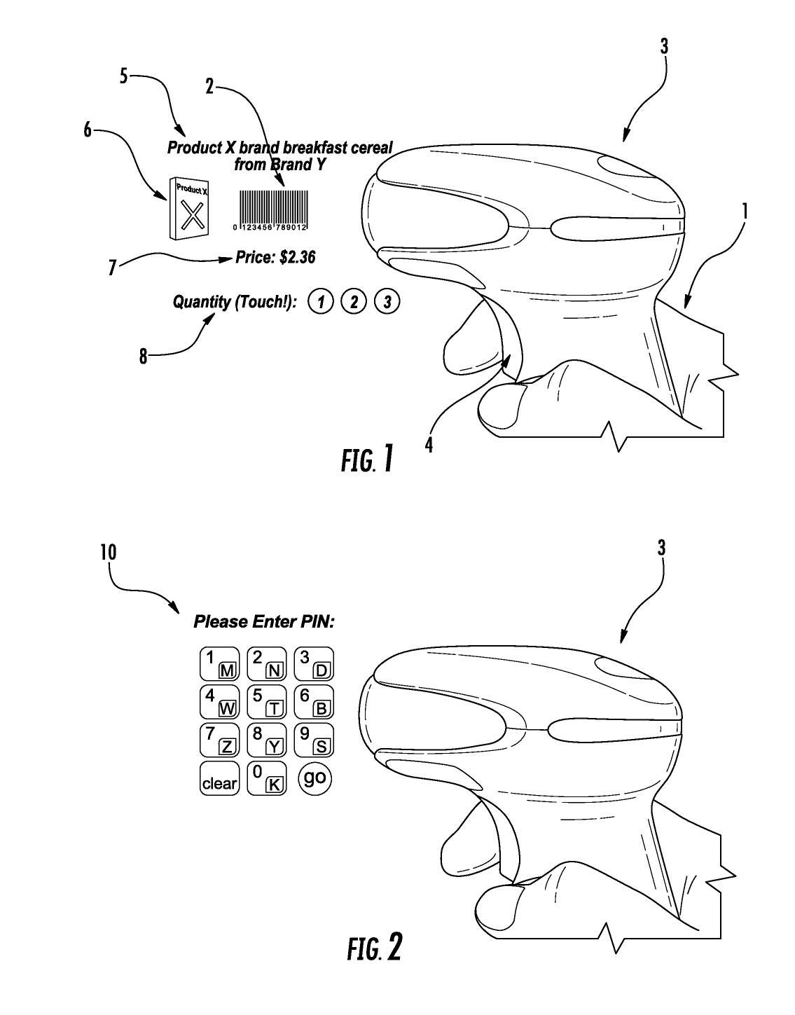

In an exemplary embodiment, shown in FIG. 1 the context-sensitive information (i.e., message) is to be displayed around a scanned barcode. Before the projection, a user 1 aligns an item's barcode 2 with the barcode reader's field of view and scans (i.e., reads) the barcode 1. After scanning, the projector module integrated with the interactive indicia reader 3 is triggered (e.g., by pressing a trigger switch 4 two times) to project a message (i.e., supplemental information) into a field of view that overlaps, at least partially, with the reader's field of view. In this case, the images and text of the supplemental information are arranged around the barcode 2. The message in this embodiment includes the item definition 5, a picture of the item 6, the item's price 7, and a prompt for a user to input the quantity 8. During projection the barcode reader allows for a user to input (e.g., with a finger touch) the desired quantity by pressing one of the virtual buttons. The imaging module captures this behavior and recognizes it as a quantity input of a particular value. This quantity information may then be passed onto another system (e.g., cash register). Alternatively the quantity selection may cause the barcode scan to be passed repeatedly to the other system, with the exact number of barcode scans passed corresponding to the quantity selected.

The selection of quantity in the embodiment above is not the only means of obtaining user-input information with input gestures. For example, in applications where multiple barcodes are within the barcode-reader field-of-view, user-input gestures (e.g., finger motion) may be captured and recognized in order to select the barcode to be decoded.

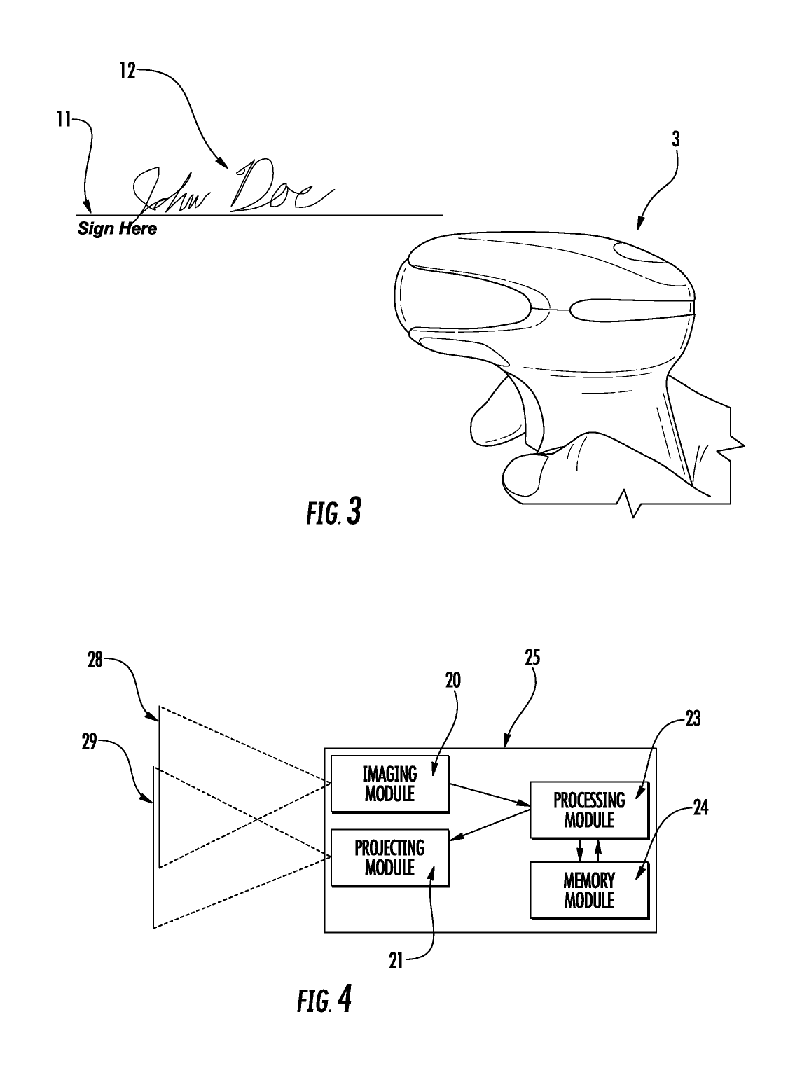

In another exemplary embodiment shown in FIG. 2, the user-input information could be a personal identification number (i.e., pin number). This information could be collected by processing user-input images to decode the gesture of pressing a series of buttons. In other words, the user-input images contain the user's interaction with a virtual control for user interaction (e.g., keypad 10). These images could be decoded into the required information (e.g., the pin number). The user may use a finger to gesture or could use another implement for pointing or drawing, such as a stylus.

In another exemplary embodiment shown in FIG. 3, a customer's signature is collected (e.g., for a credit transaction). Here the interactive indicia reader 3 projects a signature prompt 11, and the user signs his/her signature with the movement of a stylus. A series of images representing the stylus motion is collected by an imaging module and transmitted to a processor module, communicatively coupled with the imaging module. The processor processes each image in order to trace the movement of the tip of the stylus. In this way, a digital signature 12 is formed. What is more, the information of the signature may be displayed by the projecting module in order to provide a user real-time visual feedback of the digital signature 12 as the user signs.

In another exemplary embodiment, the interactive indicia reader is used as a loss prevention tool. For example, the display of supplemental information allows a retail employee to detect if a barcode of a less expensive item has be placed on a higher priced item.

In still another exemplary embodiment, customer information for verification or advertisement could be displayed using the interactive indicia reader (i.e., barcode reader). Here the reader is placed in a stand (e.g., in presentation mode) and the projected message is displayed on a surface for viewing until the next item is scanned. In this way, the customer could verify the scanned item is the item they intend to purchase. If not, a virtual button to cancel (i.e., undo) the transaction item could be pressed and the item would be removed or revised. What is more, advertisements of similar products could be displayed after a scan to recommend related items for purchase.

The previous exemplary applications could be applied to any device capable of reading indicia (e.g., barcodes) and is not limited to handheld barcode readers. For example, mobile computing devices (e.g., a smartphone with a projector) or wearable computing devices could be configured as an interactive indicia reader.

The interactive indicia reader includes several modules contained in a housing. The housing is typically gun-shaped and integrated with a trigger switch to activate different operations. For example, a single trigger pull could activate the reading of a barcode, while a double trigger pull could activate the projection of messages. The interactive indicia reader typically has a housing/controls configured for handheld use. The handheld housing makes the projection more adaptable and convenient. Configurations other than handheld, however, could be envisioned. For example, the housing could be configured to be worn (i.e., wearable) or the housing could be mounted in a stand.

An imaging module is used to capture images of indicia and/or user gestures (i.e., finger gesture or stylus gesture). The imaging module consists of optics (e.g., imaging lens) and illumination necessary to project a real image of a field of view (i.e., the barcode-reader field-of-view) onto an image sensor. The image sensor may be a sensor using CCD or CMOS technology and configured for sensitivity in the visible range of the spectrum. A monochrome image sensor or an image sensor configured for color imaging may be used. Filtering (e.g., infra-red filter) may also be used before the image sensor to reduce stray light. Illumination may be necessary to highlight targets for proper imaging. Also, alignment features may be projected to guide a user in positioning and aligning an indicia (i.e., barcode) within the field of view.

The indicia reader may process the images captured by the imaging module to decode the indicia. In some possible embodiments, decoded indicia would be available as an output of the indicia reader. In some cases, the decoding is performed by firmware on the indicia reader, while in other cases, the decoding takes place on an external device (e.g., host computer) communicatively coupled to the indicia reader.

A projection module is used to project context-sensitive information into a field of view (i.e., projector field of view). A projector may be incorporated into the barcode scanner to project context-sensitive information about a barcoded item onto a surface. This projection could be monochrome or in color. The mechanism used for projection could vary. Digital light processing (DLP), liquid crystals display (LCD) or light emitting diode (LED) based technology could be used in the projector. For example, a handheld projector (e.g., pico-projector) using lasers or LEDs, combining optics, and scanning mirror could be used to project a clear image onto a variety of viewing surfaces. For example, the surface could be a package surface or could be a counter in a check-out area.

In some embodiments, the projector module could be used to project a store's logo onto a surface (e.g., a checkout counter) while in presentation mode, that is when the indicia reader is held by a stand and not otherwise engaged in scanning. The projector module could, in another embodiment, project advertisements using either static images or moving images (i.e., dynamic video). In still another embodiment, coupon barcodes could be projected onto the surface via the projection module. The projected coupon barcodes could be scanned by a customer using a mobile computing device (e.g., a smartphone). In yet another embodiment, the projector module could be used to project an aimer pattern. The aimer pattern's shape (e.g., a crosshair) could be customizable by the user. The aimer pattern could be used to help a user align the imaging module with the barcode to be scanned.

A memory module is used to store information and software necessary for the interactive indicia reader. The memory module includes a non-transitory computer-readable storage medium and is located either on the indicia reader or an external device (e.g., host computer).

A processor module (e.g., scanner firmware) is used to control and receive data from the imaging, projection, and memory modules. The processor module may be configured by software to process an image from the imaging module. This processing includes detecting and decoding a barcode. The results of this processing may be temporarily stored in memory. The processor may then use this result, plus other stored information, to find product information associated with the scanned barcode. The product information may be formed into a message (i.e., context-sensitive information) suitable for display. The processor then may transmit this message to the projection module for projection onto a surface.

When a message is projected, the scanner begins processing images to detect motion in the field of view (e.g., gestures). Once motion is detected the images are relayed back to the processor for gesture decoding. For example, if the gesture is a virtual key press, the coordinates of the finger during pressing are recorded. The processor may then determine the key pressed by comparing these coordinates against the image of the keypad.

A host computer is required in some cases to run business logic. This business logic may determine what is displayed and how barcode reader inputs are handled. For example, a projection feature could be initiated by a double trigger pull on the reader so that the projection may be initiated by the operator only when needed.

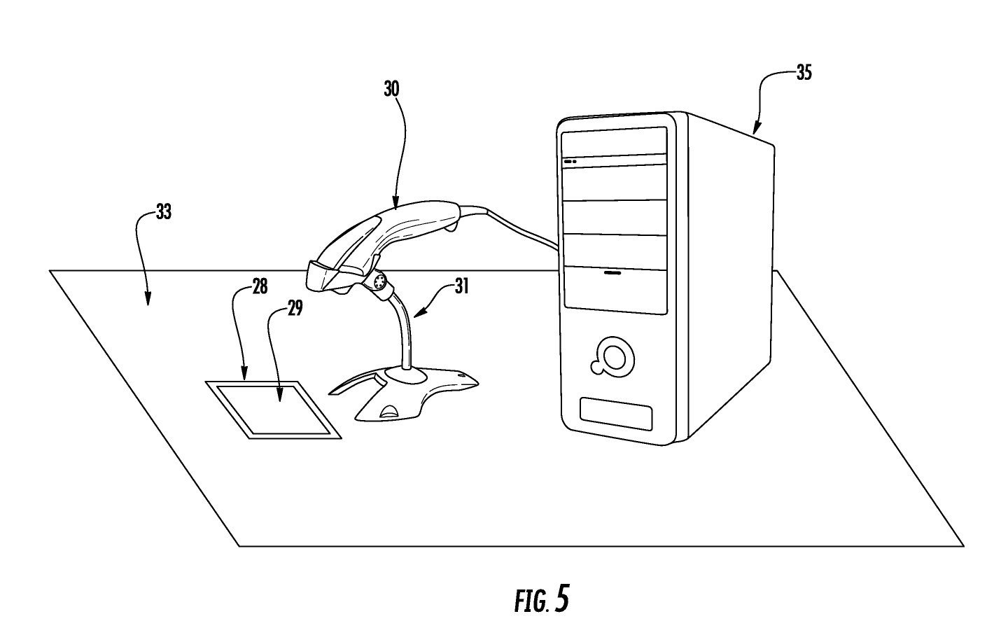

A block diagram of an exemplary interactive indicia reader is shown in FIG. 4. The imaging module 20 has an optical system that provides images of an imaging-module field-of-view 28 (i.e., barcode-reader field-of-view). Barcodes within this field of view can be recognized and decoded by the processing module 23 that is connected to the imaging module 20. The processing module 23 also controls a projecting module 21. The projecting module 21 projects messages within a projecting-module field-of-view 29 (i.e., projector field of view). These messages typically correspond to the indicia and typically represent manufacturer information or store-related information. The messages are stored in a memory module 24 and are selected and retrieved by the processing module 23. In this way, messages that correspond to the scanned barcode may be selected for display. The modules are all supported, positioned and contained by a housing 25. The housing 25 may be a variety of shapes including a gun shape to facilitate convenient holding and positioning, especially during projection.

An illustration of an exemplary interactive barcode reading system is shown in FIG. 5. The barcode reader 30 is supported and positioned by a stand 31. The stand 31 aligns the barcode reader 30 to point towards the surface 33. The barcode reader 30 is configured to read barcodes and user-input gestures within a barcode-reader field-of-view 28. A projector integrated with (e.g., within the housing) the barcode reader 30 is configured to project information (e.g., text, graphics, or images) into a projector field of view 29. A host computer 35 is communicatively coupled via either wired or wireless communication (e.g., Bluetooth) to the barcode reader 30. The host computer 35 contains memory, a processor and software to process the information from the barcode reader 30 and to generate messages for display by the projector.

The barcode reader 30 could pass decoded barcodes or barcode images suitable for decoding to the host computer. In one exemplary embodiment, barcode images are transmitted to the computer. Software running on the host computer recognizes a barcode within these images and decodes it. The software then uses this barcode information to obtain a corresponding message stored in the host computer's memory. The message is transmitted to the projector and displayed in the projector field of view 29. This message could include a prompt for a user response (e.g., select quantity). A user may respond with a user-input gesture (e.g., pressing a virtual button). User-input gestures may be formed with a finger or another implement (e.g., stylus). The imaging module in the barcode reader 30 collects images of the scene, while software on the host computer 35 examines each image for motion and/or the presence of a finger (or implement). Once a user-input gesture is recognized, software running on the host computer converts this gesture into information (e.g., quantity) and records it to memory or passes it to another system (e.g., point of sale system).

In the embodiment of FIG. 5, the projector field-of-view 29 coincides entirely with the barcode-reader field-of-view 28. While this is typical, it is not required. For example, the projector field-of-view 28 may not coincide at all with the barcode reader field of view 29. In this case, however, the supplemental information is limited to information for display since the barcode reader 30 would not be able to detect a user's interaction with the projection. In cases where the projector field-of-view 28 coincides with, at least part of, the barcode-reader field-of-view 29, the virtual control mechanisms (i.e., virtual controls) should be located within the coinciding portion.

The projection/imaging interface allows for the indicia reader to perform many more operations that allow for customer interaction. This is especially important at a point of sale (i.e., checkout). The interactive indicia reader may replace or supplement equipment, such as a display, a signature pad, or a keypad. This may be especially useful for saving space at checkout.

To supplement the present disclosure, this application incorporates entirely by reference the following patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
International Publication No. 2013/163789;
International Publication No. 2013/173985;
International Publication No. 2014/019130;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2011/0202554;
U.S. Patent Application Publication No. 2012/0111946;
U.S. Patent Application Publication No. 2012/0138685;
U.S. Patent Application Publication No. 2012/0168511;
U.S. Patent Application Publication No. 2012/0168512;
U.S. Patent Application Publication No. 2012/0193407;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0056285;
U.S. Patent Application Publication No. 2013/0070322;
U.S. Patent Application Publication No. 2013/0075168;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0200158;
U.S. Patent Application Publication No. 2013/0214048;
U.S. Patent Application Publication No. 2013/0256418;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0278425;
U.S. Patent Application Publication No. 2013/0287258;
U.S. Patent Application Publication No. 2013/0292474;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306730;
U.S. Patent Application Publication No. 2013/0306731;
U.S. Patent Application Publication No. 2013/0306734;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0313326;
U.S. Patent Application Publication No. 2013/0327834;
U.S. Patent Application Publication No. 2013/0341399;
U.S. Patent Application Publication No. 2013/0342717;
U.S. Patent Application Publication No. 2014/0001267;
U.S. Patent Application Publication No. 2014/0002828;
U.S. Patent Application Publication No. 2014/0008430;
U.S. Patent Application Publication No. 2014/0008439;
U.S. Patent Application Publication No. 2014/0021256;
U.S. Patent Application Publication No. 2014/0025584;
U.S. Patent Application Publication No. 2014/0027518;
U.S. Patent Application Publication No. 2014/0034723;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061305;
U.S. Patent Application Publication No. 2014/0061306;
U.S. Patent Application Publication No. 2014/0061307;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0075846;
U.S. Patent Application Publication No. 2014/0076974;
U.S. Patent Application Publication No. 2014/0078341;
U.S. Patent Application Publication No. 2014/0078342;
U.S. Patent Application Publication No. 2014/0078345;
U.S. Patent Application Publication No. 2014/0084068;
U.S. Patent Application Publication No. 2014/0086348;
U.S. Patent Application Publication No. 2014/0097249;
U.S. Patent Application Publication No. 2014/0098284;
U.S. Patent Application Publication No. 2014/0098792;
U.S. Patent Application Publication No. 2014/0100774;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0108682;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. patent application Ser. No. 13/367,978 for a Laser Scanning Module Employing An Elastomeric U-Hinge Based Laser Scanning Assembly, filed Feb. 7, 2012 (Feng et al.);
U.S. patent application Ser. No. 29/436,337 for an Electronic Device, filed Nov. 5, 2012 (Fitch et al.);
U.S. patent application Ser. No. 13/736,139 for an Electronic Device Enclosure, filed Jan. 8, 2013 (Chaney);
U.S. patent application Ser. No. 13/771,508 for an Optical Redirection Adapter, filed Feb. 20, 2013 (Anderson);
U.S. patent application Ser. No. 13/780,356 for a Mobile Device Having Object-Identification Interface, filed Feb. 28, 2013 (Samek et al.);
U.S. patent application Ser. No. 13/852,097 for a System and Method for Capturing and Preserving Vehicle Event Data, filed Mar. 28, 2013 (Barker et al.);
U.S. patent application Ser. No. 13/902,110 for a System and Method for Display of Information Using a Vehicle-Mount Computer, filed May 24, 2013 (Hollifield);
U.S. patent application Ser. No. 13/902,144, for a System and Method for Display of Information Using a Vehicle-Mount Computer, filed May 24, 2013 (Chamberlin);
U.S. patent application Ser. No. 13/902,242 for a System For Providing A Continuous Communication Link With A Symbol Reading Device, filed May 24, 2013 (Smith et al.);
U.S. patent application Ser. No. 13/912,262 for a Method of Error Correction for 3D Imaging Device, filed Jun. 7, 2013 (Jovanovski et al.);
U.S. patent application Ser. No. 13/912,702 for a System and Method for Reading Code Symbols at Long Range Using Source Power Control, filed Jun. 7, 2013 (Xian et al.);
U.S. patent application Ser. No. 29/458,405 for an Electronic Device, filed Jun. 19, 2013 (Fitch et al.);
U.S. patent application Ser. No. 13/922,339 for a System and Method for Reading Code Symbols Using a Variable Field of View, filed Jun. 20, 2013 (Xian et al.);
U.S. patent application Ser. No. 13/927,398 for a Code Symbol Reading System Having Adaptive Autofocus, filed Jun. 26, 2013 (Todeschini);
U.S. patent application Ser. No. 13/930,913 for a Mobile Device Having an Improved User Interface for Reading Code Symbols, filed Jun. 28, 2013 (Gelay et al.);
U.S. patent application Ser. No. 29/459,620 for an Electronic Device Enclosure, filed Jul. 2, 2013 (London et al.);
U.S. patent application Ser. No. 29/459,681 for an Electronic Device Enclosure, filed Jul. 2, 2013 (Chaney et al.);
U.S. patent application Ser. No. 13/933,415 for an Electronic Device Case, filed Jul. 2, 2013 (London et al.);
U.S. patent application Ser. No. 29/459,785 for a Scanner and Charging Base, filed Jul. 3, 2013 (Fitch et al.);
U.S. patent application Ser. No. 29/459,823 for a Scanner, filed Jul. 3, 2013 (Zhou et al.);
U.S. patent application Ser. No. 13/947,296 for a System and Method for Selectively Reading Code Symbols, filed Jul. 22, 2013 (Rueblinger et al.);
U.S. patent application Ser. No. 13/950,544 for a Code Symbol Reading System Having Adjustable Object Detection, filed Jul. 25, 2013 (Jiang);
U.S. patent application Ser. No. 13/961,408 for a Method for Manufacturing Laser Scanners, filed Aug. 7, 2013 (Saber et al.);
U.S. patent application Ser. No. 14/018,729 for a Method for Operating a Laser Scanner, filed Sep. 5, 2013 (Feng et al.);
U.S. patent application Ser. No. 14/019,616 for a Device Having Light Source to Reduce Surface Pathogens, filed Sep. 6, 2013 (Todeschini);
U.S. patent application Ser. No. 14/023,762 for a Handheld Indicia Reader Having Locking Endcap, filed Sep. 11, 2013 (Gannon);
U.S. patent application Ser. No. 14/035,474 for Augmented-Reality Signature Capture, filed Sep. 24, 2013 (Todeschini);
U.S. patent application Ser. No. 29/468,118 for an Electronic Device Case, filed Sep. 26, 2013 (Oberpriller et al.);
U.S. patent application Ser. No. 14/047,896 for Terminal Having Illumination and Exposure Control filed Oct. 7, 2013 (Jovanovski et al.);
U.S. patent application Ser. No. 14/053,175 for Imaging Apparatus Having Imaging Assembly, filed Oct. 14, 2013 (Barber);
U.S. patent application Ser. No. 14/055,234 for Dimensioning System, filed Oct. 16, 2013 (Fletcher);
U.S. patent application Ser. No. 14/053,314 for Indicia Reader, filed Oct. 14, 2013 (Huck);
U.S. patent application Ser. No. 14/065,768 for Hybrid System and Method for Reading Indicia, filed Oct. 29, 2013 (Meier et al.);
U.S. patent application Ser. No. 14/074,746 for Self-Checkout Shopping System, filed Nov. 8, 2013 (Hejl et al.);
U.S. patent application Ser. No. 14/074,787 for Method and System for Configuring Mobile Devices via NFC Technology, filed Nov. 8, 2013 (Smith et al.);
U.S. patent application Ser. No. 14/087,190 for Optimal Range Indicators for Bar Code Validation, filed Nov. 22, 2013 (Hejl);
U.S. patent application Ser. No. 14/094,087 for Method and System for Communicating Information in an Digital Signal, filed Dec. 2, 2013 (Peake et al.);
U.S. patent application Ser. No. 14/101,965 for High Dynamic-Range Indicia Reading System, filed Dec. 10, 2013 (Xian);
U.S. patent application Ser. No. 14/118,400 for Indicia Decoding Device with Security Lock, filed Nov. 18, 2013 (Liu);
U.S. patent application Ser. No. 14/150,393 for Indicia-reader Having Unitary Construction Scanner, filed Jan. 8, 2014 (Colavito et al.);
U.S. patent application Ser. No. 14/154,207 for Laser Barcode Scanner, filed Jan. 14, 2014 (Hou et al.);
U.S. patent application Ser. No. 14/154,915 for Laser Scanning Module Employing a Laser Scanning Assembly having Elastomeric Wheel Hinges, filed Jan. 14, 2014 (Havens et al.);
U.S. patent application Ser. No. 14/158,126 for Methods and Apparatus to Change a Feature Set on Data Collection Devices, filed Jan. 17, 2014 (Berthiaume et al.);
U.S. patent application Ser. No. 14/159,074 for Wireless Mesh Point Portable Data Terminal, filed Jan. 20, 2014 (Wang et al.);
U.S. patent application Ser. No. 14/159,509 for MMS Text Messaging for Hand Held Indicia Reader, filed Jan. 21, 2014 (Kearney);
U.S. patent application Ser. No. 14/159,603 for Decodable Indicia Reading Terminal with Optical Filter, filed Jan. 21, 2014 (Ding et al.);
U.S. patent application Ser. No. 14/160,645 for Decodable Indicia Reading Terminal with Indicia Analysis Functionality, filed Jan. 22, 2014 (Nahill et al.);
U.S. patent application Ser. No. 14/161,875 for System and Method to Automatically Discriminate Between Different Data Types, filed Jan. 23, 2014 (Wang);
U.S. patent application Ser. No. 14/165,980 for System and Method for Measuring Irregular Objects with a Single Camera filed Jan. 28, 2014 (Li et al.);
U.S. patent application Ser. No. 14/166,103 for Indicia Reading Terminal Including Optical Filter filed Jan. 28, 2014 (Lu et al.);
U.S. patent application Ser. No. 14/176,417 for Devices and Methods Employing Dual Target Auto Exposure filed Feb. 10, 2014 (Meier et al.);
U.S. patent application Ser. No. 14/187,485 for Indicia Reading Terminal with Color Frame Processing filed Feb. 24, 2014 (Ren et al.);
U.S. patent application Ser. No. 14/200,405 for Indicia Reader for Size-Limited Applications filed Mar. 7, 2014 (Feng et al.);
U.S. patent application Ser. No. 14/222,994 for Method and Apparatus for Reading Optical Indicia Using a Plurality of Data filed Mar. 24, 2014 (Smith et al.);
U.S. patent application Ser. No. 14/230,322 for Focus Module and Components with Actuator filed Mar. 31, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 14/249,497 for Terminal Having Plurality of Operating Modes filed Apr. 10, 2014, Grunow et al.);
U.S. patent application Ser. No. 14/250,923 for Reading Apparatus Having Partial Frame Operating Mode filed Apr. 11, 2014, (Deng et al.);
U.S. patent application Ser. No. 14/257,174 for Imaging Terminal Having Data Compression filed Apr. 21, 2014, (Barber et al.)
U.S. patent application Ser. No. 14/257,364 for Docking System and Method Using Near Field Communication filed Apr. 21, 2014, (Showering);
U.S. patent application Ser. No. 14/264,173 for Autofocus Lens System for Indicia Readers filed Apr. 29, 2014, (Ackley et al.);
U.S. patent application Ser. No. 14/274,858 for Mobile Printer with Optional Battery Accessory filed May 12, 2014, (Marty et al.);
U.S. patent application Ser. No. 14/342,544 for Imaging Based Barcode Scanner Engine with Multiple Elements Supported on a Common Printed Circuit Board filed Mar. 4, 2014 (Liu et al.);
U.S. patent application Ser. No. 14/342,551 for Terminal Having Image Data Format Conversion filed Mar. 4, 2014 (Liu et al.);
U.S. patent application Ser. No. 14/345,735 for Optical Indicia Reading Terminal with Combined Illumination filed Mar. 19, 2014 (Ouyang);
U.S. patent application Ser. No. 29/486,759 for an Imaging Terminal, filed Apr. 2, 2014 (Oberpriller et al.); and
U.S. patent application Ser. No. 14/355,613 for Optical Indicia Reading Terminal with Color Image Sensor filed May 1, 2014, (Lu et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. An interactive indicia reader comprising:
an imaging module for capturing images of (i) indicia and (ii) user gestures within a field of view;
a projecting module for projecting context-sensitive information;
a memory module for storing the context-sensitive information;
a processor module, communicatively coupled with the imaging module, the projecting module, and the memory module, the processor module configured for (i) decoding the indicia, (ii) decoding the user gestures, (iii) retrieving, from the memory module, the context-sensitive information corresponding to the decoded indicia or the decoded user gestures, and (iv) providing the context-sensitive information to the projecting module; and
a housing for supporting, positioning, and containing the modules.

2. The interactive indicia reader according to claim 1, wherein the housing has a gun shape and is integrated with a trigger switch to initiate image capture or projecting.

3. The interactive indicia reader according to claim 1, wherein the housing is configured to be worn.

4. The interactive indicia reader according to claim 1, wherein the context-sensitive information comprises manufacturer information or store-related information regarding the indicia.

5. The indicia reader according to claim 1, wherein the context-sensitive information comprises at least one virtual control for user interaction.

6. The indicia reader according to claim 1, wherein the user gestures comprise a finger.

7. The indicia reader according to claim 1, wherein the user gestures comprise a stylus.

8. An interactive barcode reading system comprising:
a barcode reader for capturing images within a barcode-reader field-of-view, said images comprising (i) barcodes and/or (ii) user-input gestures;
a projector physically integrated with the barcode reader, the projector configured to project messages within a projector field-of-view, the projector field-of-view coinciding with, at least part of, the barcode-reader field-of-view; and
a host computer communicatively coupled with the barcode reader and the projector, the host computer configured for receiving the images from the barcode reader and processing the images to (i) decode the barcodes, (ii) recognize the user-input gestures, (iii) generate messages, and (iv) transmit the messages to the projector.

9. The interactive barcode reading system according to claim 8, wherein the barcode reader and projector are wearable.

10. The interactive barcode reading system according to claim 8, wherein the barcode reader and the projector are supported and contained by a stand.

11. The interactive barcode reader according to claim 8, wherein the messages comprise images of a virtual input mechanism.

12. The interactive barcode reader according to claim 8, wherein user-input gestures comprise finger motion.

13. The interactive barcode reader according to claim 8, wherein user-input gestures comprise stylus motion.

14. A method for obtaining user-input information using a barcode reader, the method comprising:
acquiring a barcode image of a barcode on an item in a barcode-reader field-of-view;
decoding the barcode image's barcode information;
gathering supplemental information corresponding to the barcode information;
projecting the supplemental information into a projector field-of-view;
acquiring user-input images, the user-input images comprising a user's interaction with the projected supplemental information; and
decoding the user-input images to obtain user-input information.

15. The method according to claim 14, wherein the barcode reader comprises a housing and controls configured for handheld use.

16. The method according to claim 14, wherein the barcode reader comprises a smartphone.

17. The method according to claim 14, wherein the barcode reader comprises a wearable computer.

18. The method according to claim 14, wherein the user-input images comprise a finger gesture or stylus gesture.

19. The method according to claim 14, wherein the projector field-of-view coincides with, at least part of, the barcode-reader field-of-view.

20. The method according to claim 14, wherein the projector field-of-view does not coincide with the barcode-reader field-of-view.
